(19) United States
(12) Patent Application Publication
(10) Pub. No.: US 2011/0159768 A1
(43) Pub. Date: Jun. 30, 2011

(54) CARBOXYLATED LIGNIN BASED BINDERS

(76) Inventors: Stephen A. CRESCIMANNO, Hatfield, PA (US); Michael D. Kelly, North Wales, PA (US)

(21) Appl. No.: 12/974,175

(22) Filed: Dec. 21, 2010

Related U.S. Application Data
(60) Provisional application No. 61/284,998, filed on Dec. 30, 2009.

(51) Int. Cl. C08L 97/00; D04H 13/00

(52) U.S. Cl. 442/327; 524/73

(57) ABSTRACT

The present invention provides binder compositions comprising an ethylenically unsaturated carboxy acid grafted lignin or lignosulfonate component, and an oxazoline-functional group containing polymer or resin component, the two components in a solids weight ratio of from 50:50 to 98:2. As formulated, the compositions may comprise from 40 to 98 wt. % of the acid grafted lignosulfonate, preferably, 50 wt. % or more. Preferably, the binder composition further comprises one or more in situ acid generator compound to insure more rapid cure on heating or pressing. The binder enables the provision of low cost composite materials comprising a majority component derived from natural materials, and having a reasonable wet strength.

This application claims the benefit of priority under 35 U.S.C. §119(e) of U.S. Provisional Patent Application No. 61/284,998 filed on Dec. 30, 2009.

The present invention relates to binder compositions based on carboxylated lignin for use on lignocellulosic and nonwoven heat-resistant fiber substrates. More particularly, it relates to binder compositions comprising an ethylenically unsaturated carboxy acid grafted lignin or lignin derivative component and an oxazoline-functional group containing polymer or resin component in a solids weight ratio of from 50:50 to 98:2 and composites formed therefrom, including wood composites, such as medium density fiberboard (MDF) and low density fiberboard (LDF), as well as composites comprising nonwoven heat-resistant fiber substrates for use in applications such as fiberglass insulation binders and glass mats for roofing shingles.

Binders in these types of applications have generally used urea formaldehyde (UF) resins or, in some cases, phenol formaldehyde resins. Such resins pose a toxicity hazard. There is a need for a method of making heat-resistant composites utilizing binders from curable aqueous compositions which are free from formaldehyde, because of existing and proposed legislation directed to the lowering or elimination of formaldehyde. Lignosulfonate spent sulfite liquor based adhesives have demonstrated good internal bond strength of particle boards, but very poor strength retention under high moisture or water soak conditions. In this invention, lignosulfonate is grafted with ethylenically unsaturated carboxy acid monomer (methacrylic acid) through free radical polymerization to provide functionality that will react with sulfonate groups present on the lignin to promote improved moisture resistance. In addition, the carboxylated lignin is formulated with a hydrophobic oxazoline stabilized latex which also provides functionality for reaction of the grafted carboxylic acid groups for improved wet strength.

Various attempts have been made to make composites from natural binder materials, usually to take advantage of biodegradability of such products. However, such composites are costly to make and provide inferior mechanical properties.

Japan Patent Publication JP2003147309, to Kayo Sangyo Co. Ltd., discloses adhesives made from a blend of an ethylene-vinyl acetate (EVA) emulsion copolymer having carboxylic acid functional groups, a polymer having an oxazoline ring and a starch filler, such as wheat flour, rice powder, and cornstarch. The adhesives provide water resistance to decorative wooden plates and laminates, e.g. decorative veneers. However, the Koyo Sangyo adhesives failed to provide compositions having more than about 30 wt. % of natural materials; hence, the resulting adhesives may not be biodegradable. Further, the compositions comprise about 70 weight % or more of EVA and, thus, cannot provide a cost advantage when compared to compositions of natural materials.

The present inventors have endeavored to solve the problem of providing binder compositions derived primarily from natural materials for wood composites and composites comprising nonwoven heat-resistant fiber substrates that enable one to make formaldehyde free composites having acceptable mechanical properties, including wet strength.

### STATEMENT OF THE INVENTION

The present invention provides an aqueous binder composition comprising a component of one or more ethylenically unsaturated carboxy acid-grafted lignin or lignosulfonate and a component of one or more oxazoline-functional group containing polymer or resin in a solids weight ratio of from 50:50 to 98:2. In an embodiment, the solids weight ratio is from 60:40 to 98:2.

In the binder compositions as formulated for use, the compositions may comprise from 40 to 98 wt. % of the naturally derived lignin or lignosulfonate component, preferably, 50 wt. % or more.

In another embodiment, the binder composition comprises one or more in situ acid generator compound.

In yet another embodiment, the oxazoline-functional group containing polymer or resin component is selected from the group consisting of: an oxazoline-functional addition polymer that is made from ethylenically unsaturated oxazoline-functional monomer in the amount of from 10.0 to 100 wt. %, based on polymerization reaction solids; an oxazoline-functional addition oligomer that is made from ethylenically unsaturated oxazoline-functional monomer in the amount of from 10.0 to 100 wt. %, based on polymerization reaction solids; oxazoline-functionalized addition polymer; oxazoline-functionalized addition oligomer; oxazoline-functionalized resin; and mixtures thereof.

In one embodiment, the oxazoline-functional group containing polymer or resin component is a resin supported emulsion polymer.

In a different embodiment, the polymerized units of ethylenically unsaturated carboxy acid monomer in the acid-grafted lignosulfonate make up from 1 wt. % to 50 wt. %, preferably 5 wt. % to 25 wt. %, of the total weight of the acid-grafted lignosulfonate.

In one aspect of the invention, there is provided a wood composite formed from the binder composition and finely divided wood materials, wherein the weight ratio, based on solids, of the finely divided wood material and the binder composition ranges from 100:1 to 1:1. In one such embodiment, the wood composite is chosen from chipboard, particleboard, fibreboard, and oriented strand board.

In another aspect of the invention, there is provided a nonwoven composite formed from the binder composition and fibers, slivers, chips or particulate matter, wherein the weight ratio, based on solids, of the fibers, slivers, chips or particulate matter and the binder composition ranges from 100:1 to 1:1. In one such embodiment, the nonwoven composite is chosen from fiberglass, polyester, and stonewool.

The invention also provides composite materials formed from the binder composition for use in applications selected from the group consisting of: roofing, flooring, carpet backing, window treatments, ceiling tiles, wall coverings, roving, printed circuit boards, battery separators, filter stock, tape stock, composite facers, and reinforcement scrim for cementitious or non-cementitious masonry coatings.

Suitable oxazoline-functional group containing polymers or oligomers may be selected from the group consisting of: an oxazoline-functional addition polymer that is made from ethylenically unsaturated oxazoline-functional monomer in the amount of from 10.0 to 100 wt. %, based on polymerization reaction solids; an oxazoline-functional addition oligomer that is made from ethylenically unsaturated oxazoline-functional monomer in the amount of from 10.0 to 100 wt. %, based on polymerization reaction solids; oxazoline-functionalized addition polymer; oxazoline-functionalized addition oligomer; oxazoline-functionalized resin; and mixtures thereof. Suitable oxazoline-functional addition oligomers may have a number average molecular weight (Mn) ranging from 150 to 25,000. As used herein, the term “polymerization reaction solids” refers to all monomers, reactants (e.g. prepolymers) and chain transfer agents used to make a polymer.

Suitable oxazoline resins of the invention generally have greater than 10 wt. % oxazoline. Oxazoline resins are typically water soluble or water dispersible resins. In a preferred embodiment, the oxazoline polymer is a resin supported emulsion polymer.

Oxazoline-functionalized addition polymer or oligomer may be formed from any carboxylic acid-, ester- or nitrile-functional addition polymer or oligomer by reaction with one or more β-hydroxyamine, such as ethanolamine, usually in the presence of a Lewis Acid catalyst.

Preferably, the oxazoline-functional group containing polymers or oligomers are addition emulsion or solution polymers having a glass transition temperature (Tg) of from 0 to 100° C., preferably 45° C. or more.

Suitable lignins and lignosulfonates of the present invention are water soluble or water dispersible lignin or lignosulfonate with >2 wt % organic acid and/or phenolic functional groups present in their composition. In a preferred embodiment, the lignosulfonate is carboxylated by graft-copolymerization with ethylenically unsaturated carboxy acid monomers, such as (meth)acrylic acid.

In one embodiment, naturally occurring protein containing materials may be used. Suitable naturally occurring protein containing materials may contain from 10 to 100 wt. % protein and having an acid content of from 0.1 to 10 meq/g. Suitable naturally occurring proteins may be chosen from soy protein isolate, soy flour, ground flax meal, flax flour, hemp flour, flour from grains, such as those chosen from buckwheat flour, wheat flour, especially from wheat high in gluten, e.g. semolina flour, corn flour, masa, and mixtures thereof. Preferably, the naturally occurring protein is soy flour with 50 wt. % or more of soy protein.

The present invention further provides composites formed from the substrate material and the binder compositions of the present invention in a weight ratio of from 100:1 to 1:1, preferably, 25:1 or less, or, preferably 3:1 or more.

The composites according to the present invention may be wood composites chosen from chip-particle- or fibre-board, or oriented strand board, such as medium density fiberboard (MDF), or may be composites comprising nonwoven heat-resistant fiber substrates for use in applications such as fiberglass insulation binders and glass mats for roofing shingles.

All ranges recited are inclusive and combinable. For example, a proportion of 40 to 98 wt. %, or 50 wt. % or more, will include ranges of 40 wt. % or more to 50 wt. % or less, 50 wt. % or more to 98 wt. % or less, and 40 wt. % or more to 98 wt. % or less.

Unless otherwise indicated, all pressure units are standard pressure and all temperature units refer to room temperature.

All phrases comprising parenthesis denote either or both of the included parenthetical matter and its absence. For example, the phrase “(co)polymer” includes, in the alternative, polymer, copolymer and mixtures thereof.

As used herein, the term “acrylic polymer” refers to polymers comprising the polymerization product of acrylate and/or methacrylate monomers.

As used herein, the phrase “resin supported emulsion polymer” is a polymer formed by a resin supported emulsion polymerization.

As used herein, the phrase “aqueous” includes water and mixtures comprising water and one or more water-miscible solvent.

As used herein, the phrase “based on the total weight of solids” or “based on total solids” refers to weight amounts in comparison to the weight of the total composition amount of polymer, surfactant, binder, wood particles or chips (excluding moisture contained therein) and any filler or pigment.

As used herein, unless otherwise indicated, the phrase “(co)polymer” includes, independently, copolymers, terpolymers, block copolymers, segmented copolymers, graft copolymers, and any mixture or combination thereof.

As used herein, the term “component” refers to one or more ingredient. Thus, for example, a protein component may comprise soy flour, which is one material, or it may comprise a mixture of soy flour with other protein sources, such as soy protein isolate or wheat gluten.

As used herein, the term “Glass transition temperature” or “Tg” means the temperature at or above which a glassy polymer will undergo segmental motion of the polymer chain. Unless otherwise indicated, the glass transition temperatures of a polymer are calculated using the Fox equation, Bulletin of the American Physical Society 1, 3 Page 123 (1956).

As used herein, the term “(meth)acrylate” means acrylate, methacrylate, and mixtures thereof and the term “(meth)acrylic” used herein means acrylic, methacrylic, and mixtures thereof.

As used herein, the term “oligomer” refers to any molecule that has more than 2 repeat units of any monomer and has two or more oxazoline, acid, nitrile or ester functional groups.

As used herein, the phrase “wt. %” stands for weight percent.

Suitable oxazoline-functional group containing resins can comprise any resin, oligomer, or polymer product having a glass transition temperature (Tg) of from 0 to 150° C., preferably 45 to 75° C., and containing the following functional group:

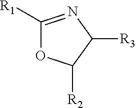

where R₁ denotes any molecule covalently bound to carbon, and where R₂ and R₃ denote hydrogen and/or a monovalent hydrocarbon radical such as H, alkyl, aryl or cycloalkyl.

Suitable oxazoline group containing polymers or oligomers can be prepared by polymerizing the corresponding oxazoline monomers. Suitable oxazoline-functionalized addition polymers or oligomers and oxazoline-functionalized resins can be prepared by functionalizing polymers, oligomers or resins that do not contain oxazoline groups, thereby attaching or forming oxazoline functional groups directly onto suitable polymer or oligomer backbones. In addition, suitable oxazoline functional resins, polymers and oligomers can be extended by reacting them with polyacids, e.g. citric acid, or carboxylic acid functional polymers or oligomers.

Suitable polymers or oligomers may be formed by copolymerizing oxazoline-functional monomers such as isopropenyl oxazoline with another addition monomer to form an addition polymer or oligomer. Suitable emulsion polymers or oligomers may be made from ethylenically unsaturated oxazoline-functional monomers in the amount of from 10.0 to 100 wt. %, preferably 20 to 100 wt. %, based on emulsion copolymer solids. Particularly preferred are monomers containing a 2-oxazoline subgroup as in 2-isopropenyl 2-oxazoline and 2-vinyl 2-oxazoline. Suitable non-oxazoline containing addition monomers may include, for example, acrylates, methacrylates and vinyl monomers, such as styrene. One suitable oxazoline-functional emulsion copolymer may comprise copolymers of methyl methacrylate (MMA), butyl acrylate (BA), 4.0 isopropenyl oxazoline, and allyl methacrylate (AM).

Suitable oxazoline functionalized resins, oligomers and polymers may be formed by condensation and cyclization of one or more β-hydroxyamine or β-hydroxyamine functional polymer, oligomer or resin with one or more carboxylic acid functional polymer, oligomer or resin, e.g. oligo(acrylic acid) or citric acid, nitrile functional polymer, oligomer or resin, e.g. (co)polyacrylonitrile, or ester functional polymer, oligomer or resin, e.g. polymethyl methacrylate. Examples of this embodiment include the reaction of polynitriles with ethanolamine or the condensation and cyclization of polymethyl methacrylate with ethanolamine.

Preferably, oxazoline functionalized resins, oligomers and polymers are prepared through the reaction of one or more suitable β-hydroxyamine, e.g ethanolamine with one or more nitrile containing polymer, oligomer or resin. An example of a suitable oxazoline-functional addition polymer or oligomer is one wherein the oxazoline rings are formed by reacting the nitrile groups in aqueous media with an excess of one or more ethanolamine, optionally in the presence of an excess of an amine, such as ammonia. More preferably, the oxazoline rings in the oxazoline functionalized resins, oligomers and polymers are formed in any nitrile functional group containing polymer, oligomer or resin, by reacting the nitrile groups of the resin or polymer in aqueous media with an excess of one or more β-hydroxyamine, such as ethanolamine, in the presence of an amine and/or a Lewis acid catalyst, e.g. AlCl₃.

In another embodiment, the oxazoline functionalized resins, oligomers and polymers may be formed by cyclization of functional groups already present on the polymer, oligomer or resin (i.e. without the addition of β-hydroxyamine). Examples of this embodiment include the cyclization of poly(2-hydroxymethacrylamide) or poly(2-chloromethacrylamide).

In yet another embodiment, the oxazoline functionalized resins, oligomers and polymers may be formed by or by dehydration of a corresponding β-hydroxyamine group in the polymer, oligomer or resin, which then forms the oxazoline ring. The dehydration methods are milder but may require the use of expensive dehydration agents.

In yet still another embodiment, oxazoline functionalized resins, oligomers and polymers can be prepared by covalently attaching one or more oxazoline-containing resin to a polymer or oligomer, such as an addition polymer or oligomer. Examples of this approach include the reaction of an acid containing polymer with excess bis-oxazoline small molecule or the condensation reaction of a polyaromatic aldehyde oligomer with methyl oxazoline.

Preferably, any polymer, oligomer or resin is functionalized in the absence of water and while removing water of condensation as the oxazoline rings form.

Suitable β-hydroxyamines may include ethanolamine, diethanolamine and triethanolamine.

Suitable nitrile function resins include maleic dinitrile, adipodinitrile oxalodinitrile, butanedinitrile, succinic dinitrile, azelaic dinitrile, terephthalic dinitrile, phthalic dinitrile, and citric trinitrile.

Suitable nitrile functional addition (co)oligomers or polymers that can be oxazoline functionalized include those made by (co)polymerizing (meth)acrylonitrile as a comonomer with other addition monomers.

Suitable carboxylic acid resins are the polycarboxylic acids and oligomers may include, for example, dicarboxylic acids, such as oxalic acid, maleic acid, butanedioic acid, succinic acid, adipic acid, azelaic acid, terephthalic acid and phthalic acid and larger Mw polyesters made from diacids with diols or diepoxies; tricarboxylic acids, such as citric acid and/or polyester reaction products of triols and diacids; and polymeric acids, such as oligo(meth)acrylic acids having from greater than 3 acid groups.

The number average molecular weight of the oxazoline-functional addition oligomers may range from 150 to 25,000, or, preferably, 5,000 or less. The number average molecular weight of the oxazoline functionalized polymers may range up to 300,000.

In another embodiment, the molecular weight of oxazoline functional resins or oligomers may be increased by the advancement of polyfunctional oxazoline oligomers or resins with diacids and triacids or other polyacids, e.g. in the presence of a trialkyltin catalyst, or by addition polymerization with a polyacid addition polymer. Suitable carboxylic acids for use in making the oligomers may comprise dicarboxylic acids, tricarboxylic acids, and polymeric acids, as described above.

In an embodiment, the wood adhesive binder compositions may be formed as an aqueous slurry or dispersion of the naturally occurring protein component and the oxazoline-functional group containing polymer or resin. This composition can be mixed with finely divided wood. Alternatively, in a two component system, one component is chosen from the naturally occurring protein component in dry form, lignins, lignosulfonates, and their mixtures, and the other comprises an aqueous solution or emulsion of the oxazoline-functional group containing polymer or resin. In the two component system, the dry naturally occurring protein component is applied to the finely divided wood and the aqueous solution or emulsion of the oxazoline-functional group containing polymer or resin is applied thereto, such as by spraying.

The wood adhesive binder compositions may comprise formulations including ingredients other than the oxazoline-functional group containing polymer or resin component and the naturally occurring protein component. However, the proportion of naturally occurring protein in the wood adhesive binder composition formulation should range 40 wt. % or more, or, preferably, 50 wt. % or more, and up to 98 wt. %.

Formulations of the wood adhesive binder composition may comprise up to 30 wt. %, based on total solids, of one or more polymer or copolymer formed by polymerization of ethylenically unsaturated monomers, such as acrylic polymers made from alkyl (meth)acrylates like methyl methacrylate or butyl acrylate; poly (meth)acrylic acid; vinyl polymers, such as styrene acrylates, vinyl ester polymers, such as polyvinyl acetate and ethylene-vinyl acetate copolymer (EVA), or copolymers of vinylacetate with acrylic monomers; and styrene-butadiene rubber (SBR).

In another embodiment, formulations of the wood adhesive binder composition may be combined with one or more cross-linker shortly before use. Suitable cross-linkers are isocyanates, monomers or polymers containing acetoacetoxy groups, adipic acid, melamine formaldehyde resin, urea formaldehyde resin, melamine salts, aldehydes such as glutaraldehyde, glyoxal, and polymeric aldehydes, such as dialdehyde starches, and complexing agents, such as zirconium salts. Preferably, polymers containing acetoacetoxy groups are used as cross-linker, such as copolymers of acetoacetoxyethyl methacrylate. Suitable amounts of cross-linker may range up to 20 wt. %, or 0.1 wt. % or more.

Formulations of the wood adhesive binder compositions can comprise one component or two component systems. The formulations may further comprise additives in the amount of up to 20 wt. %, based on total solids, including natural binders, such as lignins and lignosulfonates, viscosity adjusting agents and fillers, such as kaolin or walnut shell meal, defoamers, biocides and pH adjusting agents. Preferably, the wood adhesive binder further comprises one or more lignosulfonate.

The wood adhesive binder reacts more slowly when formulated at a pH above 4.5. However, lignosulfonates or lignins if used will react with the oxazoline-functional group containing polymer or resin component at a lower pH. To increase cure rates, one can heat the binder system more to compensate for the higher pH.

In wood adhesive binder compositions that do not contain lignosulfonates or lignins, to promote the cure of the wood adhesive binder compositions of the present invention, the pH of the wood adhesive binder can be formulated at a pH of 4.5 or less, or, 2.0 or higher. Suitable pH adjusting agents may include polycarboxylic acids, such as citric acid, and mineral acids, such as sulfuric acid. At such a pH, naturally occurring proteins such as soy protein become cationic and a mixture with an oxazoline-functional group containing polymer or resin component will remain stable. The thus protonated oxazoline-functional group containing polymer or resin component will react with the carboxyl functional groups of the naturally occurring protein component. Accordingly, the acid can be added to the wood adhesive binder formulation just prior to use or the acid can be kept separate from the oxazoline-functional group containing polymer or resin in a two component formulation.

To promote reactivity, one or more in situ acid generator can be used in any of the binder compositions formulated at pH of 4.5 or higher. Preferably, in situ acid generator may be used to formulate stable fluid one component formulations of the binder compositions comprising lignosulfonate or lignins. Any such formulations may have a pH of 4.5 or higher, or, preferably, 6.0 or higher, such that the composition would, when applied to a substrate and heated or pressed, generate acid to promote the reaction of the oxazoline-functional group containing polymer or resin component with the naturally occurring protein component and/or lignosulfonate.

Suitable in situ acid generator compounds may include metal persulfate salts, ammonium persulfate salts, organic thermal acid generators, e.g. triphenyl sulfonium hexafluoroantimonate, redox catalyst couples such as bisulfite salts mixed with an oxidant, e.g. hydrogen peroxide or persulfate salts, and acid-amine salt compounds. In situ acid generation may be achieved by heating persulfate or the redox couple to generate acid. When using a redox couple, preferably one of the redox pair components is reserved until just before addition to the wood particles to prevent premature acid generation.

Suitable acid-amine salt compounds may be made by adding amine to water and then adding the acid to the aqueous amine. Examples of the amine may include, for example, ammonia, methylamine, dimethylamine, trimethylamine, ethylamine, diethylamine, triethylamine, butylamine, tributylamine, monoethanolamine, diethanolamine, triethanolamine, diethylethanolamine, ethylenediamine, N,N-dimethylethylenediamine, and morpholine. Examples of the acid may include, for example, inorganic acids, such as phosphoric acid, phosphorous acid, hydrochloric acid, sulfuric acid, nitric acid and the like; and organic sulfonic acids such as methanesulfonic acid, p-toluenesulfonic acid and the like. The acid-amine salt compounds may be added in a total amount of from 0.1 to 15 wt. %, based on the total of binder solids.

In embodiments where the compositions of the present invention comprise lignosulfonate, to insure fluidity of the compositions, the higher the pH the better. A low pH may cause the protonated oxazoline-functional group containing polymer or resin component and the lignosulfonate, which is anionic at the desired formulation pH's with its strong acid groups, to precipitate out. To prevent this, the oxazoline-functional group containing polymer or resin component and lignosulfonate can be formulated as separate components that are not mixed together prior to addition to wood particles, i.e. a two component system.

In an initial test with 10 wt. % aqueous ammonium persulfate, based on total binder solids, as an in situ acid generator compound, (a mixture of 62.5 wt. % lignosulfonate and 37.5 wt. % WS-700 based on solids) a board with good performance was achieved. The initial pH of the lignosulfonate/WS-700 blend with 10% ammonium persulfate was 6.2. At press temperatures persulfate has a short half-life for decomposition to sulfate radical anion; then, hydrogen atom abstraction by these radical then generates hydrogen sulfate, a strong acid.

A measure of cured board pH can be obtained by soaking a piece of particle board in a specific weight of water and measuring the pH of the aqueous phase. As measured in this way, the 10% ammonium persulfate gave a board with pH equivalent to that of a board where 4.3 wt % sulfuric acid (based on total binder) was used as a pH adjuster.

The wood composites according to the invention may be chosen from chip-, particle- or fibre-board, and oriented strand board. One example of a suitable fibreboard is medium density fiberboard (MDF).

To make the wood composites, the wood adhesive binder compositions are mixed with finely divided wood chosen from fibres, chips, or particle materials of one or more different type of wood. As used herein, the term “wood chips” includes chips, shavings, flakes, sawdust particles and any similar finely divided wood based material. The moisture content of suitable finely divided wood material may range from 0 to 20 wt. %, preferably, up to 10 wt. % %, or, more preferably, from 1 to 8 wt. %.

The weight ratio of finely divided wood to wood adhesive binder composition, is suitably from 100:1 to 1:1, preferably, 25:1 or less, or, preferably, 3:1 or more. The methods for forming composites according to the present invention comprise mixing the wood adhesive binder adhesive composition and the finely divided wood, followed by pressing. The pressing suitably takes place at an elevated temperature. For particle-, chip-, and fibre-board products, the pressing temperature may range from 20 to 250° C., most preferably from 70 to 200° C. For laminated products, such as laminated flooring or veneered flooring products, the preferred pressing temperature may range from 70 to about 175° C.

The pressing time and pressing temperature are linked so that lower pressing temperatures generally require longer pressing times. The wood based product to be produced also determines suitable pressing temperatures and pressing times. Suitable pressing times may range from 10 s to 60 minutes, or, preferably 30 s or more, or up to 30 minutes, or, most preferably, 1 minute or more, or, up to 5 minutes.

The wood based product of the invention can be a flooring material, a veneered furniture material, a wall panel, or a composite product such as a particle board, fibre board, chip board, oriented strand board. The wood based product of the invention is preferably a veneered furniture material, veneered flooring, laminated flooring or a particle board.

### EXAMPLES

Samples of wood furnish (finely divided wood) were sieved to the isolate material with the desired particle size, large particles were screened out using a #10 mesh screen and fine particles removed using a #60 mesh screen. The wood furnish had a moisture content of approximately 5%.

Particleboard samples were prepared by transferring approximately 360 grams of wood furnish/binder blend (8 wt. % binder on wood solids) to a 280 mm×280 mm×64 mm (11′×11″×0.25″) aluminum pre-mold sitting on an aluminum plate. A spatula was used to level the contents of the pre-mold, and gentle pressure was applied to the top of the wood furnish/binder blend using a Plexiglas™ (Arkema, Colombes, FR) plastic tamper. The pre-mold was removed leaving aluminum shims (64 mm, 0.25″) to control the final board thickness. The assembly was transferred into an automated laboratory hydraulic press (Carver, Model#4533, Wabash, Ind.). The press platens were held at 180° C., and pressing was achieved using a clamping force of 13600 Kg (30000 lbs) which was maintained for 3 minutes. The pressure was then released and the boards were removed from the press, cooled on a metal table, and then subjected to destructive testing.

Destructive Testing: Boards were first cut into specimens using a band-saw, such that eight 25 mm×130 mm (1″×5″) pieces were obtained for flexural strength measurements (measurement of modulus of elasticity, MOE, and modulus of rupture, MOR), four 51 mm×51 mm (2″×2″) pieces were obtained for thickness swell measurements, and four 51 mm×51 mm (2″×2″) pieces were obtained for internal bond strength measurements. These tests were done in accordance with ASTM D1037-06a (May 10, 2007). Scrap pieces were used to determine final moisture content of the pressed board, by monitoring water weight loss after 72 hours in a 105° C. oven.

### Example 1

### Soy Flour/Oxazoline Functional Latex Binder

Binder A: Soy flour/oxazoline functional latex wet blends were prepared by first diluting 30 grams of a commercial oxazoline functional latex comprising the polymerization product of ˜20% isopropenyl oxazoline (40 wt. % solids), Epocros™ K-2020E (Nippon Shokubai, Osaka, Japan) with 78 grams water. This mixture was agitated using an overhead stirrer equipped with a propeller stirrer at a speed sufficient to create a vortex and 20 grams of Soy flour (Cargill Prolia 100/90, Minneapolis, Minn.), was then added portion-wise with stirring to the mixture to make Binder A. The pH of the resulting mixture was 6.5. Water was added to adjust final binder solids to 25%. Blends at different pH's were obtained by adding aqueous solutions of sulfuric acid or sodium hydroxide to the blend prior to final solids adjustment.

A control binder of soy flour alone was prepared in a similar fashion. A standard urea formaldehyde (UF) resin control binder was also prepared by diluting a commercial UF resin (Casco Resin, CR583, (Hexion Specialty Materials, Columbus, Ohio), with water and adding an ammonium chloride (2% based on UF resin solids) acid catalyst; the final solids of the UF control binder was 49.2%.

Particleboard furnish and binder blends were prepared by first charging wood furnish (FP Innovations-Forintek Division, Quebec, Canada) (350 grams) into a kitchen-style mixing bowl. The bowl was placed onto a kitchen mixer (Kitchen Aid, Artisan model, Division of Whirlpool, Benton Harbor, Mich.) and gentle agitation was provided using a 3-blade paddle. The wet blends prepared as above were added using a pipette, so that the final binder solids weight was 8% (based on dry binder weight and dry wood weight). Particleboard samples were prepared and tested as described in the general methods section. Results are shown in Table 1, below.

TABLE 1

| | | | Board | MOE | MOR | 24 Hr | Internal Bond |
|---|---|---|---|---|---|---|---|
| | Binder | Moisture | Density | MPa | MPa | Swell in | Strength |
| Binder | pH | Content % | g/cc | (psi) | (psi) | water,% | MPa (psi) |
| A | 2.0 | 22.4 | 0.85 | 2500 (360000) | 18 (2600) | 38 | 1.2 (170) |
| A | 6.5 | 22.4 | 0.80 | 2100 (310000) | 16 (2300) | 42 | 0.34 (50) |
| A | 9.0 | 22.4 | 0.83 | 2000 (300000) | 15 (2200) | 41 | 0.17 (24) |
| A | 12.0 | 22.4 | 0.81 | 2000 (290000) | 14 (2000) | 42 | 0.57 (83) |
| Soy | | 21.4 | 0.81 | 2000 (290000) | 14 (2000) | 52 | 0.54 (78) |
| control | | | | | | | |
| UF | | 17.7 | 0.78 | 2100 (310000) | 16 (2300) | 46 | 1.3 (190) |
| control | | | | | | | |

As shown in Example 1, even with 67.5 wt. % of soy flour, based on total binder solids, at a formulation pH of 2.0 the wood binder adhesives provide exceptional modulus of elasticity, modulus of rupture and swelling properties, and good bond strength. Even at a higher formulation pH, the wood binder adhesives provide good modulus of elasticity, modulus of rupture and swelling properties; however, swelling improves at a lower formulation pH.

### Example 2

### Soy Flour/Oxazoline Functional Aqueous Solution Polymer Binder

Particleboard furnish/binder blends were prepared by first charging 350 grams of wood furnish (FP Innovations-Forintek Division) and 25 grams of dry soy flour (Cargill Prolia 100/90) into a kitchen-style mixing bowl. The bowl was placed onto a kitchen mixer (Kitchen Aid, Artisan model), and gentle agitation was provided using a 3-blade paddle. Diluted (25%) aqueous sulfuric acid, 0.23 grams, was added to the stirring mixture. To Make Binder B in situ with wood, 5.3 grams of a commercial oxazoline functional aqueous solution polymer having an Mn of 2,700 made from polymerization of 50 wt. % of isopropenyl oxazoline, Epocros WS-700 (Nippon Shokubai), was diluted with 54 grams of water and added by pipette to the acidified wood/soy flour mixture. The final mixture contained a binder solids weight of 8% (based on dry binder weight and wood solids weight) with a soy flour to WS-700 dry weight ratio of 95:5. The final moisture content was 17.5%.

In a similar fashion, blends with other ratios of soy flour to WS-700 were prepared. In those blends the final total binder level was maintained at 8% and the moisture content maintained at 17.5%. Sulfuric acid was used at 0.04 gram of 25% solution for every 1 gram of WS-700 used to give a pH of about 3.5. Also in a similar fashion a soy alone control binder was prepared. A blend with a standard urea formaldehyde (UF) resin control binder was also prepared by diluting a commercial UF resin, (Casco Resin, CR583), with water, adding an ammonium chloride (2% based on UF resin solids) acid catalyst; and adding the mixture to wood furnish. Particleboard samples were prepared and tested as described in the general methods section. Results are shown in Table 2, below.

TABLE 2

| | | Board | MOE | MOR | 24 Hr | Internal Bond |
|---|---|---|---|---|---|---|
| | Moisture | Density | MPa | MPa | Swell in | Strength |
| Binder | Content % | g/cc | (psi) | (psi) | water, % | MPa (psi) |
| B | 17.5 | 0.82 | 1700 (250000) | 11 (1600) | 69 | 0.15 (23) |
| 90 Soy | 17.5 | 0.79 | 1800 (260000) | 12 (1800) | 66 | 0.21 (30) |
| Flour | | | | | | |
| 10 WS-700 | | | | | | |
| 85 Soy | 17.5 | 0.78 | 2000 (290000) | 14 (2000) | 64 | 0.21 (31) |
| Flour | | | | | | |
| 15 WS-700 | | | | | | |
| 80 Soy | 17.5 | 0.78 | 1900 (280000) | 14 (2000) | 63 | 0.37 (53) |
| Flour | | | | | | |
| 20 WS-700 | | | | | | |
| Soy Flour | 17.5 | 0.79 | 1800 (260000) | 11 (1700) | 89 | 0.47 (68) |
| control | | | | | | |
| UF control | 12.5 | 0.76 | 1300 (180000) | 10 (1500) | 70 | 0.63 (91) |

When formulated with sulfuric acid, the wood adhesive binder of Example 2 exhibits good mechanical and swelling properties even with 80 wt. % and up to 95 wt. % of soy, based on binder solids.

### Example 3

### Lignosulfonate/Oxazoline Functional Aqueous Solution Polymer Binder

Particleboard furnish/binder blends were prepared by first charging 350 grams of wood furnish (American Wood Fibers, Columbia, Md.) into a kitchen-style mixing bowl. The bowl was placed onto a kitchen mixer (Kitchen Aid, Artisan model), and gentle agitation was provided using a 3-blade paddle. Diluted (25%) aqueous sulfuric acid, 4.8 grams, was added to the stirring wood furnish. To make Binder C in situ with the wood, 33 grams of Lignosulfonate (Arbo™ S01 Tembec Inc. Montreal, Canada) and the commercial oxazoline functional aqueous solution polymer, Epocros WS-700 (Nippon Shokubai), 40 grams, were each diluted with about 15 grams of water and added sequentially by pipette to the acidified wood furnish. Binder C contained a binder solids weight of 8% (based on dry binder weight and dry wood weight) with a lignosulfonate to WS-700 dry weight ratio of 62.5:37.5. The final moisture content was approximately 22%.

In a similar fashion a lignosulfonate alone control binder was prepared. A blend with a standard urea formaldehyde (UF) resin control binder was also prepared by diluting a commercial UF resin, (Casco Resin, CR583), with water, adding an ammonium chloride (2% based on UF resin solids) acid catalyst; and adding the mixture to wood furnish. Particleboard samples were prepared and tested as described in the general methods section. Results are shown in Table 3, below.

TABLE 3

| | | Board | MOE | MOR | 24 Hr | Internal Bond |
|---|---|---|---|---|---|---|
| | Moisture | Density | MPa | MPa | Swell in | Strength |
| Binder | Content % | g/cc | (psi) | (psi) | water, % | MPa (psi) |
| C | 22.3 | 0.82 | 2600 (380000) | 16 (2300) | 33 | 0.75 (110) |
| Ligno- | 22.4 | 0.70 | 2100 (310000) | 6.5 (950) | Breaks | 0.11 (16) |
| sulfonate | | | | | apart | |
| control | | | | | | |
| UF control | 12.5 | 0.80 | 1100 (160000) | 11 (1600) | 31 | 0.96 (140) |

The Example 3 binder provides excellent mechanical, swelling and bond strength properties in comparison to the UF control when the formulation comprises an oxazoline functional group containing resin or polymer component and lignosulfonate. As shown in the lignosulfonate control, without the oxazoline functional group containing resin or polymer component, the board disintegrates in water.

### Example 4

### Carboxylated Lignosulfonate/Oxazoline Functional Aqueous Polymer Binder

### Synthesis of Latex A—Oxazoline Functional Latex

A solution consisting of 1368 g Epocros WS-700 (A commercial oxazoline functional aqueous solution polymer; Nippon Shokubai) and 431 g deionized water and 0.0057 g ferrous sulfate is warmed to 50° C. A monomer mixture consisting of 476 g deionized water, 5.7 g sodium lauryl sulfate, 585 g butyl acrylate and 441 g methyl methacrylate is gradually added to the reactor over 60 minutes. The monomer mixture is fed along with an aqueous solution consisting of 33.1 g deionized water and 8.75 g t-butyl hydroperoxide (70%) and a second aqueous solution consisting of 262 g deionized water, 0.35 g aqueous ammonia (28%) and 5.86 g sodium sulfoxylate formaldehyde. After completion of all feeds, the reaction product is maintained at 50° C. for an additional 10 minutes and then an aqueous solution consisting of 20 g deionized water and 4.37 g t-butyl hydroperoxide (70%) is gradually added over 20 minutes along with a second aqueous solution consisting of 20 g deionized water and 2.62 g of sodium sulfoxylate formaldehyde. The batch is cooled and filtered to remove any gel or coagulum. Latex A had solids content of 37.1%.

### Synthesis of Latex B—Oxazoline Functional Latex

Latex B followed a procedure identical to Latex A except for the monomer mixture which was augmented with 10.43 g of aqeuous ammonia (28%) and 21 g methacrylic acid. Latex B had solids content of 37.8%.

### Synthesis of Acid Grafted Lignosulfonate

The procedure for preparing acid grafted lignosulfonate is based on known methods (for example, R. Chen et. al., J. of Appl. Poly. Sci., 32, 4815 (1986)). The grafted lignosulfonate used in the results below consisted of an ammonium lignosulfonate grafted with 10% methacrylic acid (based on lignosulfonate solids). It had final solids of 46.4% and a pH of 7.3.

### Lap Shear Tensile Strength for Bonded Maple Veneer Samples

The lap shear tensile strength test was adapted for use from the test method procedure disclosed in U.S. Pat. No. 7,252,735 B2, to K. Li (Example 3). The binder compositions shown in Table 4, below, were formulated by simple admixture at room temperature using a benchtop stirrer. The resulting aqueous solution was used as an adhesive for maple veneers as follows.

A 5 inch×5 inch (12.7 cm×12.7 cm) piece of veneer was cut in half to form two equal strips, and the top half inch (1.2 cm) was marked off to indicate where the binder would be applied. The binder composition for testing was applied to one side at the marked off top end of the maple veneer strip, adding the binder composition to equal weight from one sample to the next. Two pieces of maple veneer strips were stacked together and hot-pressed, using a Carver press, at 110-120° C. for 1 minute or 2 minute time periods. The applied pressure was 1,000 psi. The samples were then allowed to equilibrate overnight at room temperature. Dry and Hot/Dry tensile testing were performed using an Instron tensile tester, using a 2 inch (5 cm) gap between the jaws of the Instron. Hot/dry samples were allowed to equilibrate to 120° C. for 1.5 minutes before testing. The wet strength was evaluated by submerging a 1 inch×5 inch (2.5 cm×12.7 cm) strip of the pressed board in deionized water for 4 hours and for 24 hours before being tested using the Instron tensile tester. For each type of conditioning, there were samples that had been in the Carver press for 1 minute, and samples that had been in the Carver press for 2 minutes. All tests were performed in duplicate (2 bonded strips per test condition).

TABLE 4
Binder Composition Formulations (in grams, wet)

| Sample | Ligno- | Grafted | | | | |
|---|---|---|---|---|---|---|
| No. | sulfonate | Lignosulfonate | Latex A | Latex B | APS | WS-700 |
| 1 | 9.80 | — | — | — | — | — |
| 2 | — | 10.78 | — | — | — | — |
| 3 | 7.06 | — | 4.16 | — | 0.93 | — |
| 4 | 9.80 | — | 5.78 | — | 1.30 | 1.20 |
| 5 | 9.80 | — | — | 5.67 | 0.90 | — |
| 6 | — | 10.78 | — | — | 1.29 | 8.57 |
| 7 | — | 10.78 | 5.78 | — | 1.29 | 1.20 |
| 8 | — | 10.78 | — | 5.67 | 1.29 | 1.20 |

1. Each of the formulations is approximately 48% solids (+/−2%), except sample No. 6 was 41% solids.
2. Samples 1 and 2 use the lignosulfonate (51% solids) and grafted lignosulfonate (46.4% solids), respectively, as the sole binder component. For each of the other formulations, the lignosulfonate component is approximately 59% wt. %, based on solids, of the total solids; the latex is approximately 25 wt. %, and the ammonium persulfate (APS) approximately 15%. When present, WS-700 is used as a minor additive (3.5 wt. %), except in Sample 6 where it replaces the latex polymer and is present at a level of approximately 25 wt. %.

The results obtained for the lap shear tensile testing of samples 1-8 are given in Table 5, below.

TABLE 5
Lap Shear Tensile Strength for Bonded Carver Pressed Maple Veneers

| | Lap Shear Tensile Strength (Newtons) | | | | | | | |
|---|---|---|---|---|---|---|---|---|
| Sample | Dry | Dry | Hot/Dry | Hot/Dry | Wet 4 hr. | Wet 4 hr. | Wet 24 hr. | Wet 24 hr. |
| No. | 1 min. | 2 min. | 1 min. | 2 min. | 1 min. | 2 min. | 1 min. | 2 min. |
| 1 | 341 | 496 | 218 | 263 | 0 | 0 | 0 | 0 |
| 2 | 444 | 433 | 185 | 277 | 0 | 0 | 0 | 0 |
| 3 | 521 | 935 | 230 | 283 | 224 | 87 | 131 | 190 |
| 4 | 752 | 966 | 328 | 371 | 82 | 200 | 96 | 206 |
| 5 | 931 | 802 | 451 | 445 | 8 | 204 | 35 | 173 |
| 6 | 931 | 933 | 709 | 847 | 216 | 205 | 220 | 310 |
| 7 | 1050 | 948 | 349 | 360 | 475 | 341 | 473 | 355 |
| 8 | 932 | 994 | 572 | 588 | 165 | 184 | 155 | 149 |

The data in Table 5 show clear lines of differentiation when viewed according to wet tensile strength. Samples 1 and 2 use the lignosulfonate and grafted lignosulfonate respectively, as the sole binder component. In both cases the wet tensile strength is zero for all test conditions. Lignosulfonates are not suitable for use as stand alone binders in applications that require any degree of wet strength. Samples 3, 4, and 5 are all formulated binders that comprise a regular lignosulfonate. Although formulating with oxazoline functional group containing latexes clearly builds some wet strength, the binder compositions comprising regular lignosulfonates are lacking in wet strength compared to samples 6, 7, and 8, which all comprise an ethylenically unsaturated carboxy acid grafted lignosulfonate and oxazoline functional group containing latex.

We claim:

1. An aqueous binder composition comprising a component of one or more ethylenically unsaturated carboxy acid-grafted lignin or lignosulfonate and a component of one or more oxazoline-functional group containing polymer or resin in a solids weight ratio of from 50:50 to 98:2.

2. The aqueous composition as claimed in claim 1, wherein the solids weight ratio is from 60:40 to 98:2.

3. The aqueous composition as claimed in claim 1, wherein the binder composition comprises one or more in situ acid generator compound.

4. The aqueous composition as claimed in claim 1, wherein the oxazoline-functional group containing polymer or resin component is selected from the group consisting of: an oxazoline-functional addition polymer that is made from ethylenically unsaturated oxazoline-functional monomer in the amount of from 10.0 to 100 wt. %, based on polymerization reaction solids; an oxazoline-functional addition oligomer that is made from ethylenically unsaturated oxazoline-functional monomer in the amount of from 10.0 to 100 wt. %, based on polymerization reaction solids; oxazoline-functionalized addition polymer; oxazoline-functionalized addition oligomer; oxazoline-functionalized resin; and mixtures thereof.

5. The aqueous composition as claimed in claim 1, wherein the oxazoline-functional group containing polymer or resin component is a resin supported emulsion polymer.

6. The aqueous composition as claimed in claim 1, wherein the polymerized units of ethylenically unsaturated carboxy acid monomer in the acid-grafted lignosulfonate make up from 1 wt. % to 50 wt. % of the total weight of the acid-grafted lignosulfonate.

7. A wood composite formed from the binder composition of claim 1 and finely divided wood materials, wherein the weight ratio, based on solids, of the finely divided wood material and the binder composition ranges from 100:1 to 1:1.

8. A wood composite as claimed in claim 7 chosen from chipboard, particleboard, fibreboard, and oriented strand board.

9. A nonwoven composite formed from the binder composition of claim 1 and fibers, slivers, chips or particulate matter, wherein the weight ratio, based on solids, of the fibers, slivers, chips or particulate matter and the binder composition ranges from 100:1 to 1:1.

10. A nonwoven composite as claimed in claim 9 chosen from fiberglass, polyester, and stonewool.

11. A composite material formed from the binder composition of claim 1 for use in applications selected from the group consisting of: roofing, flooring, carpet backing, window treatments, ceiling tiles, wall coverings, roving, printed circuit boards, battery separators, filter stock, tape stock, composite facers, and reinforcement scrim for cementitious or non-cementitious masonry coatings.
